(19) United States
(12) Patent Application Publication
(10) Pub. No.: US 2009/0289840 A1
(43) Pub. Date: Nov. 26, 2009

(54) Process for Optimizing Status Notifications in the Case of a Navigation Satellite System

(75) Inventor: Hans L. TRAUTENBERG, Ottoburnn (DE)

Correspondence Address: CROWELL & MORING LLP;INTELLECTUAL PROPERTY GROUP, P.O. BOX 14300, WASHINGTON, DC, 20044-4300, US

(73) Assignee: Astrium GmbH, Muenchen (DE)

(21) Appl. No.: 12/470,221

(22) Filed: May 21, 2009

(30) Foreign Application Priority Data
May 26, 2008 (DE) 102008025063.5-55

(51) Int. Cl. G01S 1/00

(52) U.S. Cl. 342/357.01

(57) ABSTRACT

A process for optimizing status notifications in the navigation satellite system includes the following steps: the determination of information concerning a communication network of the navigation satellite system; and the transmission of the determined information as a status notification in at least one navigation message.

### BACKGROUND AND SUMMARY OF THE INVENTION

This application claims the priority of German patent document 10 2008 025 063.5-55, filed May 26, 2008, the disclosure of which is expressly incorporated by reference herein.

The invention relates to a process for optimizing status notifications in a navigation satellite system.

Global Navigation Satellite Systems (GNSS), also referred to herein as Navigation Satellite Systems, are used for position indication and navigation on the ground and in the air. GNSS Systems, such as the European Navigation Satellite System (in the following, also called the Galileo System or simply Galileo), which is currently being constructed, include a satellite system (space segment) comprising a plurality of satellites, an earth-fixed receiving device system (ground segment), which is connected with a central computing station and comprises several ground stations as well as Galileo sensor stations. User systems evaluate and utilize the satellite signals transmitted from the satellites by wireless communication, particularly for the navigation. The ground stations also transmit status notifications, for example, concerning the technical condition of all satellites in the space segment and the integrity of the system, which notifications can be received and evaluated by the user systems.

Because of the topology of the communication network in navigation satellite systems like the Galileo, as a rule, several ground stations may fail simultaneously because communication elements are used jointly by several ground stations. Unless there is a total failure of communication as a result of, for example, a failure of communication elements, the continuity of the communication in the navigation satellite system may, however, deteriorate. In particular, the transmission of status notifications may deteriorate, which is especially disadvantageous for the safety-critical service (Safety of Life (SoL) service) provided in the case of the Galileo.

It is therefore an object of the present invention to provide a process for optimizing status notifications in the case of a navigation satellite system.

This and other objects and advantages are achieved by the process and system according to the invention, in which information concerning a communication network of a navigation satellite system, such as the topology of the communication network or the expected continuity of its communication elements, is transmitted to user systems for further processing. A user system can thereby compute the expected continuity of the availability of observation data of the navigation satellite system. This process permits optimization of status notifications in the navigation satellite system because a user system can calculate a possibly impaired continuity of the communication, particularly of status notifications, by processing of the received information concerning the communication network, a precision with which distance measurements can be carried out.

According to an embodiment of the invention, a process is provided for optimizing status notifications in the case of a navigation satellite system, having the following steps:
Determination of information concerning a communication network of the navigation satellite system; and
transmission of the determined information as a status notification by means of one or more navigation messages. As a result of the transmission of information concerning the communication network, a user system can determine the continuity to be expected, and based thereon emit, for example, a warning message concerning a reduction of distance measurements based on navigation messages that could possibly be expected.

According to the invention, the step of determining information concerning a communication network of the navigation satellite system can comprise the following steps:
Determining the topology of a communication network of the navigation satellite system; and
determining the expected continuities of communication elements of the communication network. The latter can enable a user system to develop a precise estimate of a continuity of navigation messages to be expected, because knowledge of the topology and of the expected, continuities of the communication elements permits an overall estimate of the continuity in the navigation satellite system.

According to a further embodiment of the invention, the transmission of the determined information concerning a communication network of the navigation satellite system can take place in the form of a navigation message that is repeated more slowly than normal navigation messages. As a result, the flow of communication in the navigation satellite system is affected only a little by the transmission of the information on the communication network.

According to another embodiment of the invention, the step of transmitting the failure of one or more communication elements is performed by one or more alert messages, which rapidly inform the user systems concerning the failure, so that the latter can newly compute the continuity and, as required, adapt to the newly computed continuity. Furthermore, as a result, faults which the availability of measuring data of several ground stations of the navigation satellite system can now be disseminated clearly more effectively in alert messages.

In particular, according to an embodiment of the invention, an alert message may contain an identification of the failed communication element, so that the user systems will be able to compute as precisely as possible the continuity change because of the failure. This eliminates the necessity of marking every individual observation station as unavailable in a single alert message, because the isochronous failure of several observation stations is almost always caused by the failure of elements of the communication.

The invention also relates to a navigation satellite system, which comprises a space segment having satellites which emit satellite signals containing navigation messages for receipt and analysis by user systems, for the position determination and navigation, and a ground segment having several observation and command stations monitoring the satellites. One or more of the observation and command stations are constructed for executing a process according to the invention and described above, in order to optimize the status notifications in the navigation satellite system. In such a navigation satellite system, on the one hand, a user system can clearly better model the efficiency of the observation system for its purposes, and, on the other hand, different user demands can better be satisfied by means of a single data stream.

Furthermore, the invention provides a method for processing a status notification transmitted by a navigation message in a navigation satellite system, having the following steps:
Receiving of a navigation message with the status notification which was generated and transmitted by means of a process according to the invention, as described above;
determining the information concerning the communication network of the navigation satellite system contained in the status notification of the received navigation message, and
computing the expected continuity of availability of observation data in the navigation satellite system on the basis of the determined information concerning the communication network of the navigation satellite system.

Finally, the invention provides a receiver for signals of a navigation satellite system which contain navigation messages. The receiver is constructed to implement a process for processing a status notification transmitted by means of a navigation message in a navigation satellite system according to the invention, as explained above. For example, the process can be implemented in the operating software of a receiver for navigation messages, such as a navigation device. As a result, the functionality of the receiver can be expanded, in that it can, more precisely than previously, inform a user concerning a possible problem in the continuity, as well as the continuity to be expected.

Other objects, advantages and novel features of the present invention will become apparent from the following detailed description of the invention when considered in conjunction with the accompanying drawings.

### BRIEF DESCRIPTION OF THE DRAWINGS

FIG. 1 is a view of a navigation satellite system with an embodiment of a system for optimizing status notifications in a navigation satellite system according to the invention; and

FIG. 2 is a flow chart of an embodiment of a process for optimizing status notifications in the case of a navigation satellite system according to the invention.

### DETAILED DESCRIPTION OF THE DRAWINGS

The terms and assigned reference symbols used in the attached list of reference symbols will be used in the specification, in the claims, in the abstract and in the drawings. The same and/or functionally identical elements may be provided with the same reference symbols.

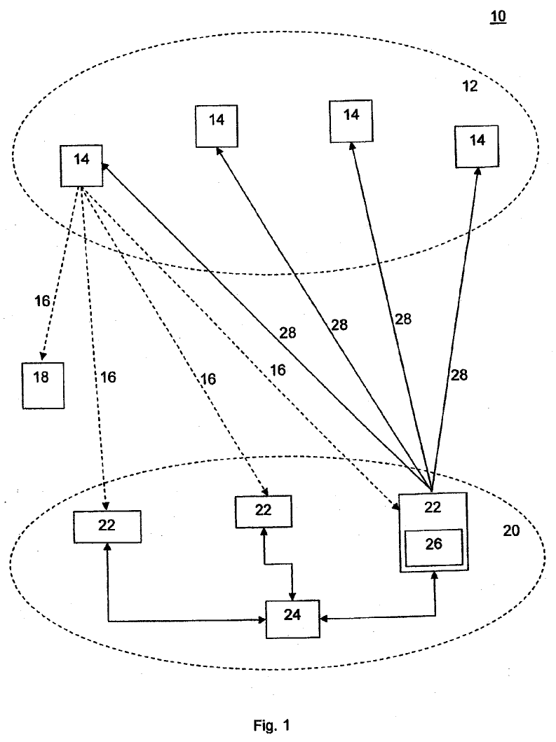

FIG. 1 illustrates a navigation satellite system 10 having a space segment 2 and a ground segment 20. The space segment 12 comprises several satellites 14, each of which orbits around the ground segment 20. Each satellite emits satellite signals 16, which can be received by user systems 18, such as mobile navigation devices, as well as by observation and command stations 22 of the ground segment 20. The satellite signals 16 contain navigation messages of the navigation satellite system 10, which navigation messages contain orbital parameters for the description of the orbit.

The observation and command stations 22 which, in the case of the Galileo System, are designed as separate units, are provided particularly for the monitoring and controlling of the satellites 14. For this purpose, they transmit received navigation signals 16 by way of a communication network to a control center 24 (central processing point of the ground segment 20) which analyzes the received navigation signals 16. That is, it examines the data of a satellite 14 transmitted with each navigation signal 16, particularly the orbit and point in time of the generating of the signal as well as the signal structure and integrity of the received signals. The observation and command stations 22 further generate navigation messages 28, which may contain the previously mentioned status notifications (for example, concerning the technical condition of all satellites of the space segment and the integrity), and continuously send them to the satellites 14 for the continuous further distribution to the use systems 18. From the navigation messages 28 received by means of the satellite signals 16, a user system 18 can obtain information concerning the integrity, and thus the reliability, of the received navigation-relevant data.

Particularly for critical services, like the initially mentioned SoL Service in the case of Galileo, a continuous data stream in the communication network of the ground segment 20 is significant because it ensures that the user systems 18 utilizing the SoL Service are notified as fast as possible of problems in the navigation system 10. An example of a SoL Service is satellite-supported navigation during an approach of an airplane.

The topology of the communication network of the Galileo is therefore basically constructed such that, even in the event of a failure of individual communication elements, such as one or more observation stations 22, a continuous data stream is maintained. However, the system continuity may be impaired by the failure, and may mainly deteriorate, for example, by an increase of the delay time before an important message arrives at a user system. As a result of a failure, the propagation time of messages which are transmitted from the ground segment 20 by way of the space segment 12 to the user systems 18 may increase, or the continuity of the messages emitted from the ground segment 20 may fluctuate.

The navigation messages 28 emitted by the ground segment 20 therefore contain information concerning the communication network of the navigation satellite system 10, such as the topology of the communication network and the expected continuities of communication elements of the communication network. In an observation and command station 22, this information may also be embedded in a navigation message 28, which, in comparison to normal navigation messages, is transmitted to the user systems 18 by way of the satellite signals 16 at a slower rate of repetition. By means of this information, a correspondingly constructed user system 18 can compute the expected continuity, particularly of the availability of observation data at the control center 24.

Should a communication element (for example, a satellite 14 or an observation and command station 22) have failed, an alert message can also be sent out with a navigation message 28 from a ground and command station 22. This alert message may contain information concerning the failed element, so that, based on the information concerning the communication network (particularly the topology and the expected continuities of the individual communication elements) and the information concerning the failed element, a user system 18 can compute the continuity with which observations are available at the control center 24. By means of the information available at the control center 24, a user system 18 can then further determine the precision with which distance measuring signals can be observed. The higher the demand of the user system 18 for continuity, the poorer the assumed precision of the observation, since several observations are required for providing the continuity.

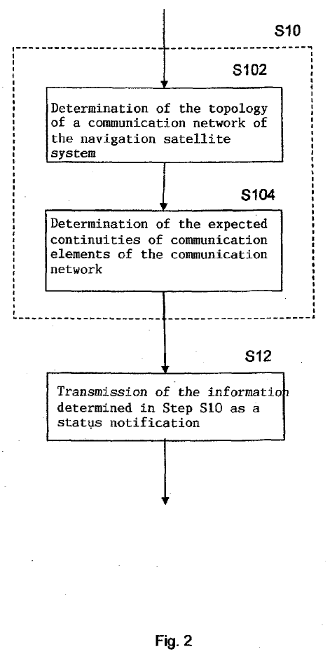

For embedding the topology information and expected continuity information in a navigation message 28, an observation and command station 22 has corresponding processor devices 26, which are configured to implement the process illustrated by the flow chart in FIG. 2, for example, in that they implement corresponding algorithms.

According to the course of the process depicted in FIG. 2, information concerning a communication network of the navigation satellite system is first determined in Step S10, which is divided into two substeps: In Step S102, the topology of a communication network of the navigation satellite system is determined first. (The topology can be stored, for example, in the control center 24 and can be retrieved by an observation and command station 22 by way of the communication network.) In the subsequent Step S104, the expected continuities of communication elements of the communication network will then be determined. Data concerning the expected continuities of the communication elements can be stored, for example, in a data bank of the control center 24 and can be retrievable by the observation and command stations 22.

For carrying out Step S10, the processor devices 26 of the observation and command station 22 can, for example, first initiate the querying of the topology from the control center and intermediately store data concerning the topology received from the control center 24, in order to subsequently identify the communication elements indicated in the data concerning the topology and retrieve their expected continuities from the data bank of the control center 24. From the date thus obtained, the processor devices 26 can subsequently generate a navigation message 28 which is transmitted to the satellites 14 of the space segment 12 in a slow sequence. The information concerning the communication network contained in the transmitted navigation message 28 represents status notifications concerning the navigation satellite system in a broader sense, and concerning the communication network of the navigation satellite system in a narrower sense. The control center 24 can further automatically signal changes of the topology and of the expected continuities to the individual observation and command stations 22 of the ground segment 20, so that these can automatically correspondingly adapt the slowly repeating navigation message.

As a result of the invention, a user system of a navigation satellite system can better model the efficiency of an observation system of a navigation satellite system for its purposes. Furthermore, it becomes possible to meet users' various demands by means of a single data stream because the user systems will be able to carry out their own computations concerning the continuity to be expected by means of the transmitted information relative to the communication network. Furthermore, faults relating to the availability of measuring data of several ground stations, particularly observation and command stations, can be disseminated significantly more effectively in alert messages. Finally, the necessity of marking each individual observation and command station as unavailable in a single alert message can be eliminated, because the isochronous failure of several observation stations is almost always caused by the failure of elements of the communication in the navigation satellite system.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### Reference Symbols

10 Navigation satellite system

12 Space segment

14 Satellites

16 Satellite signals

18 User systems

20 Ground segment

22 Observation and command stations

24 Control center

26 Processor devices for navigation messages 28

28 Navigation message of an observation and command station 22

S10-S12 Process steps

What is claimed is:

1. A process for optimizing status notifications in a navigation satellite system, said process comprising:
determining information concerning a communication network of the navigation satellite system; and
transmitting the determined information as a status notification in at least one navigation message.

2. The process according to claim 1, wherein the step of determining information concerning a communication network of the navigation satellite system comprises:
determining topology of a communication network of the navigation satellite system; and
determining expected continuities of communication elements of the communication network.

3. The process according to claim 1, wherein the transmission of the determined information concerning a communication network of the navigation satellite system takes place in the form of a navigation message which repeats more slowly than in normal navigation messages repeat.

4. The process according to claim 1, further comprising by transmitting a failure of one or more communication elements in at least one alert message.

5. The process according to claim 4, wherein said at least one alert message contains an identification of the failed communication element.

6. A navigation satellite system comprising a space segment that includes satellites emitting satellite signals which contain navigation messages for the receipt and analysis by user systems for position indication and navigation, and a ground segment that includes a plurality of observation and command stations which monitor the satellites; wherein at least one of the observation and command stations is configured to implement a process for optimizing status notifications in the navigation satellite system, including determining information concerning a communication network of the navigation satellite system; and transmitting the determined information as a status notification in at least one navigation message.

7. A process for processing a status notification transmitted with a navigation message in a navigation satellite system, said process comprising:
receiving a navigation message with a status notification which was generated and transmitted by a process that includes determining information concerning a communication network of the navigation satellite system, and transmitting the determined information as a status notification in at least one navigation message;
determining the information concerning the communication network of the navigation satellite system contained in said status notification; and
computing expected continuity of the availability of observation data in the navigation satellite system based on the determined information concerning the communication network of the navigation satellite system.
